(19) United States
(12) Patent Application Publication
(10) Pub. No.: US 2008/0239746 A1
(43) Pub. Date: Oct. 2, 2008

(54) Headlamp for Vehicles

(75) Inventors: Martin Wuller, Warendorf (DE); Nikolaus Decius, Lippstadt (DE); Karsten Eichhorn, Wadersloh (DE); Mirco Gotz, Lippstadt (DE); Susanne Hagedorn, Lippstadt (DE); Christian Luder, Bielefeld (DE)

Correspondence Address: HUSCH BLACKWELL SANDERS LLP, 190 CARONDELET PLAZA, SUITE 600, ST. LOUIS, MO, 63105-3441, US

(73) Assignee: Hella KGaA Hueck & Co., Lippstadt (DE)

(21) Appl. No.: 12/064,915

(22) PCT Filed: Aug. 25, 2006
(86) PCT No.: PCT/EP2006/065665

§ 371 Date: Feb. 26, 2008

(30) Foreign Application Priority Data
Aug. 31, 2005 (DE) 10 2005 041 234.3

(51) Int. Cl. B60Q 1/00

(52) U.S. Cl. 362/538

(57) ABSTRACT

The present invention relates to a headlamp for vehicles with a plurality of LED light sources combined into a single light-emitting surface, where an optical unit is allocated to at least one LED light source to generate some of a specified light distribution, where one or several LED light sources can be turned on or off such that the light distribution can be modified, where a first optical unit with first projection characteristics is placed before a first group of LED light sources and a second optical unit with second projection characteristics is placed before a second group of LED light sources such that a number of differently sized light spots can be generated in the traffic space by optionally turning on or off or dimming the LED light sources of the first group of LED light sources or the second group of LED light sources.

### CROSS-REFERENCE TO RELATED APPLICATIONS

This application claims priority to international application PCT/EP2006/065665 filed on Aug. 25, 2006 which claims priority to German application DE 10 2005 041 234.3 filed Aug. 31, 2005.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to a headlamp for vehicles comprising a plurality of LED light sources that share the same light-emitting surface such that an optical unit is allocated to at least one LED light source to generate some of a predefined light distribution, and such that groups of one or several LED light sources can be turned on or off in a way that will modify the light distribution.

2. Related Art

DE 100 09 782 A1 describes a headlamp for vehicles with a plurality of LED light sources which are arranged in the shape of a matrix. An optical unit designed as a converging lens is placed before the matrix of LED light sources with the option of placing a diaphragm between the matrix and the converging lens in order to generate a line cutting off the light distribution projected by the converging lens. Being able to separately actuate the LED light sources allows different light distributions to be generated. However, since all LED light sources share but a single converging lens, their variability in generating different light distributions is limited.

DE 102 05 779 A1, describes a headlamp for vehicles with a plurality of LED light sources, each of which is allocated to an optical unit. The optical unit is an arrangement of microlenses which are located immediately inside the LED light source. Whereas differently driving the LED light sources allows different light distributions to be generated, each of the LED light sources will produce spots of light of an identical size because all optical units have the same projection characteristics.

### SUMMARY OF THE INVENTION

The task of the present invention is to further develop a headlamp for vehicles with a plurality of LED light sources such that it provides technically simple and efficient means of improving the provisioning of light distributions that are adapted to the road space.

To face this challenge, the invention is characterized by a first optical unit with a first set of projection characteristics that is placed before a first group of LED light sources and a second optical unit with a second set of projection characteristics that is placed before a second group of LED light sources such that the LED light sources of the first group of LED light sources or the second group of LED light sources can be optionally turned on or off or dimmed to generate a number of differently sized spots of light in the road space.

The particular advantage of the invention is that only a limited number of grouped LED light sources is necessary to produce a large number of different light distributions. An inventive headlamp incorporates different optical units with different sets of projection characteristics which are allocated to the groups of LED light sources such that different light distributions can be produced depending on whether one or several LED light sources of the first group of LED light sources and the second group of LED light sources or further groups are driven. For example, combining or overlapping groups of LED light sources allows the generation of light distributions for low beam or high beam or bend lighting or marker light functions or light distribution for motorway driving. The invention utilizes the fact that different projection characteristics will convert the same beam of light rays emitted by each of the LED light sources into differently sized spots of light in the road space.

One practical use is that this feature allows a leveling of some parts of a light distribution in conformity with statutory regulations. Or some very limited parts of the light distribution could be highlighted or blanked out.

In a further development of the invention, a first group of LED light sources and a first optical unit generate a first partial light distribution and a second group of LED light sources and a second optical unit generate a second partial light distribution, wherein the first partial light distribution and the second partial light distribution illuminate different road spaces. Making the two partial light distributions overlap results in a beam pattern that complies with the demanded light distribution. The second partial light distribution, some of which is located above the first partial light distribution, is preferably made up of small spots of light such that a comparatively brightly lit area could be produced near a cut-off line.

In a further development of the invention, a control unit is allocated to the groups of LED light sources which makes the light distribution dynamically move along in steering direction when the vehicle drives through a curve. The lift of the cut-off line is made to move in the direction of the curve by specifically turning on or off the LED light sources of one group of LED light sources. This is an advantageous means of generating a dynamic shift in the light distribution.

In a further development of the invention, the control unit is allocated to a sensor unit which is able to detect the relative position between the vehicle and a hazard point and/or another traffic object in the road space. The control unit affects the LED light sources such that the hazard point is optically highlighted by turning on or off or dimming LED light sources so that the hazard point is more clearly visible to the driver.

Furthermore, the control unit can affect the LED light sources such that some of the illuminance is reduced to stop dazzling other traffic objects such as oncoming vehicles. This is achieved by detecting the relative position between the vehicle and the other traffic object and giving less light to the light distribution area that corresponds to the other traffic object such that dazzling the other traffic object will be avoided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 a schematic view of a headlamp with, by way of example, two groups of LED light sources and optical units allocated to said groups,

FIG. 2 a schematic view of a light distribution generated by the headlamp, illustrating the different areas illuminated by the groups of LED light sources

FIG. 3a a first partial light distribution for low beam as generated by a first group of LED light sources.

FIG. 3b a second partial light distribution for low beam as generated by a second group of LED light sources.

FIG. 3c the light distribution for low beam resulting from the partial light distributions generated by the two groups of LED light sources as shown in FIG. 3a and FIG. 3b.

FIG. 4 a resulting light distribution for low beam while the vehicle is going through a left-hand curve.

FIG. 5a a first partial light distribution for a motorway light generated by the first group of LED light sources.

FIG. 5b a second partial light distribution for motorway light generated by the second group of LED light sources.

FIG. 5c a resulting light distribution for a motorway light.

### DETAILED DESCRIPTION OF THE PREFERRED EMBODIMENTS

The following description of the preferred embodiment(s) is merely exemplary in nature and is in no way intended to limit the invention, its application, or uses.

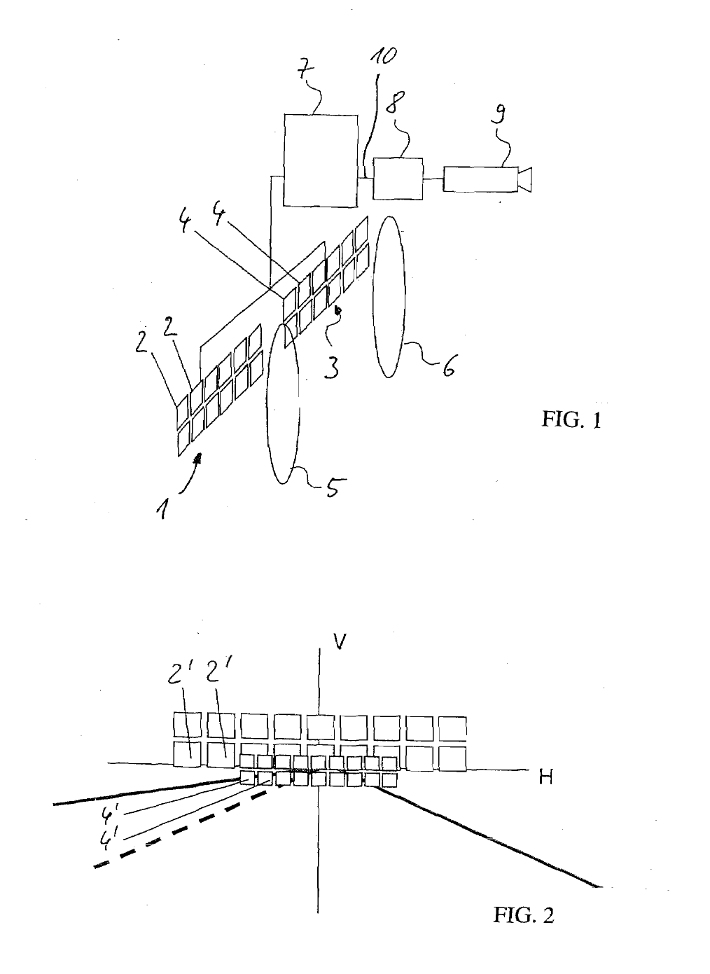

FIG. 1 is a schematic view of an inventive headlamp for vehicles. The headlamp consists of optical components comprising a first group 1 of LED light sources 2 and a second group 3 of a plurality of LED light sources 4. The LED light sources are designed as LED chips (light-emitting semiconductor diodes) which are arranged into groups—i.e. a first group 1 and a second group 3—to make up a light-emitting surface on a shared substrate but each in its own LED chip array.

The first group 1 of LED light sources 2 is allocated a first optical unit 5 and the second group 3 of LED light sources 4 is allocated a second optical unit 6, each of which said optical units are located before the group 1 and the second group 3 of LED light sources. Every LED light source 2, 4 of the first group 1 and the second group 3 is of the same make and design.

The first optical unit 5 has first projection characteristics which project the light emitted by the LED light sources 2 of the first group 1 as a comparatively large spot of light 2′ to an area mainly above a horizontal line H. The second optical unit 6 has second projection characteristics which project the light emitted by the LED light sources 4 of the second group 3 as a comparatively small spot of light 4′ to an area symmetrically above and below the horizontal line H. The illuminance of light spots 4′ 4—is greater than the illuminance of light spots 2′.

A control unit 7 is placed before the groups 1, 3 of LED light sources 2, 4. Said control unit is an electronic component which can individually turn on or off or dim any of the LED light sources 2, 4 of groups 1, 3.

On the input side of control unit 7, a signal processing unit 8 is provided for, and on the input side of signal processing unit 8, a sensor unit 9 is provided for. When the vehicle is in motion, sensor unit 9 will detect objects in the road space ahead of the vehicle and output a sensor signal to signal processing unit 8. The signal processing unit 8 checks if the detected objects could constitute a potential risk of an unwanted accident. If the detected object classifies as a potential risk, a control signal 10 will be output to control unit 7 such that the danger point represented by the detected object is optically highlighted by accordingly actuating the LED light sources 2, 4 in order to warn the driver of the vehicle of the danger point. LED light sources 2, 4 will be driven dynamically by detecting the changing dimension of the danger point and accordingly driving the LED light sources 2, 4 such that the changing position of the danger point is given more light for increased illumination.

Illumination of the danger point can be particularly improved by dimming up the LED light sources 2, 4 allocated to the place of the danger point. Potential danger points include pedestrians, cyclists or larger pieces of stone. Additionally or alternatively, signal processing unit 8 can also analyze a traffic object such as an oncoming vehicle such that the area represented by the traffic object is given less light for illumination to avoid unwanted glare to the traffic object. This will “undazzle” the traffic object while retaining perfect illumination of the area adjacent to the traffic object.

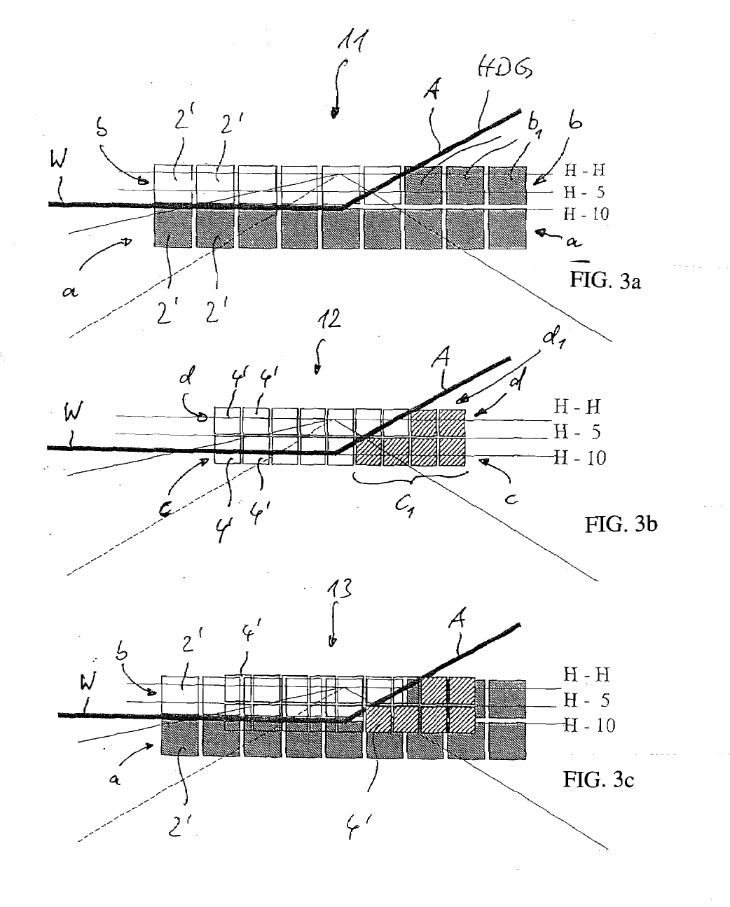

FIGS. 3a, 3b and 3c illustrate how a low beam light distribution is provided. FIG. 3a shows the controllable light spots 2′ of the first group 1 of LED light sources 2. The first optical unit 5 generates a bottom row a of light spots 2′ in an area mainly underneath a horizontal line W of the cut-off line HDG but such that a top edge of the light spots 2′ is tangential to the horizontal line W. A top row b of light spots 2′ follows immediately above the bottom row a. To generate a first partial light distribution 11 for the low beam, the LED light sources 2 are driven to produce the bottom row a of light spots 2′. Only three of the possible light spots 2′ in the top row b are generated in an area b, to produce a line A at an asymmetrical 15° inclination.

FIG. 3b shows a second partial light distribution 12 for the low beam made up of a bottom row c and a top row d of light spots 4′. The bottom row c of light spots 4′ more or less symmetrically follows the horizontal line W. This will therefore produce four light spots 4′ in area c, of the bottom row c.

In the top row d; two light spots 4′ are generated in area d, to reflect the asymmetrical inclination A. The overlap between the first partial light distribution 11 and the second partial light distribution 12 results in a low beam light distribution 13 as shown on FIG. 3c where light spots 2′, 4′ appear as hatchings.

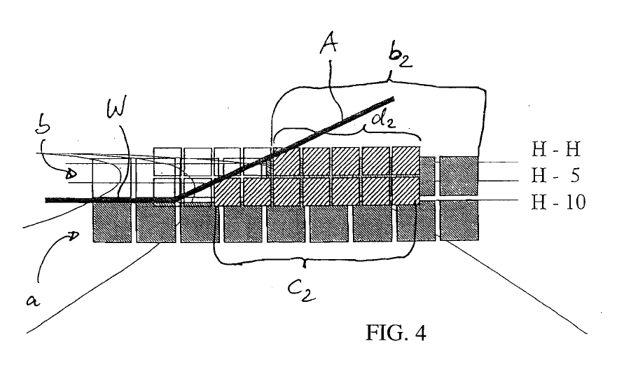

When the vehicle drives round a left-hand curve as shown in FIG. 4, previously non-activated LED light sources 2, 4 of the first group 1 or the second group 3 are turned on one by one, the effect being that the asymmetrical inclination A moves in the direction of the curve, i.e. towards the left, to produce a low beam light distribution with bend lighting. FIG. 4 shows how the number b₂ of light spots 2′ generated in the top row b of the first partial light distribution 11 and the number c₂, d₂ of light spots 4′ in the bottom row c and the top row d of the second partial light distribution 12 are increased compared to driving straight ahead as shown in FIG. 3c.

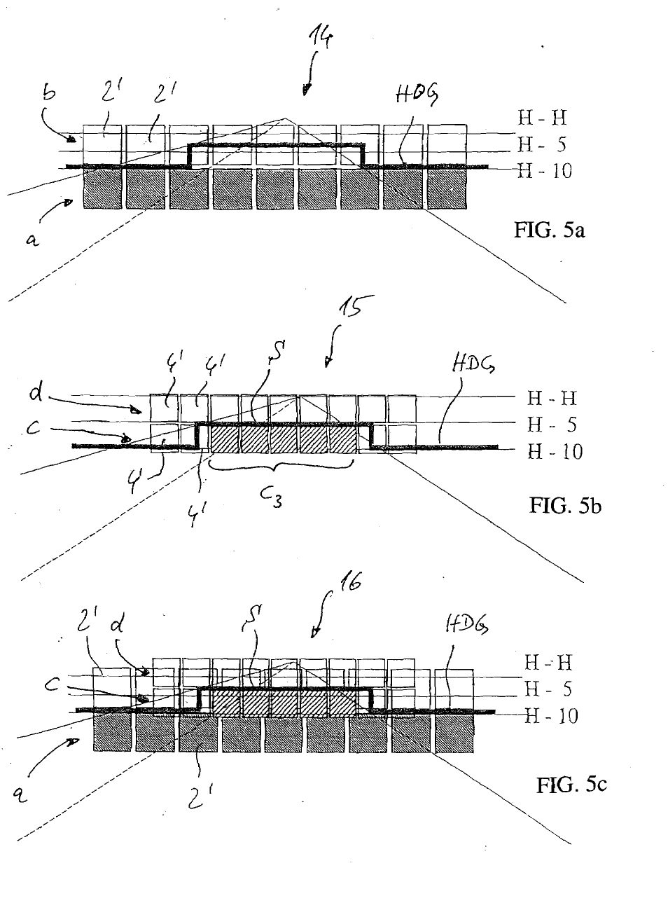

FIGS. 5a, 5b and 5c show the overlap between a first partial light distribution 14 and a second partial light distribution 15 that makes up a resulting motorway light distribution 16. Only those of the LED light sources 2 of the first group 1 are turned on that are needed to generate the bottom row a of light spots 2′. Only those of the LED light sources 4 of the second group 3 are turned on that are needed to generate some light spots 4′ from the bottom row c in area C₃ that reflect a middle step section S of the cut-off line HDG. The advantage of this illumination is that it lights up an extended area of the road space by utilizing the comparatively small but high-illuminance light spots 4′ for long-range lighting.

The invention benefits from the fact that the second optical unit 6 projects the light from the second group 3 of LED light sources 4 such that at least some of the corresponding light spots 4′ of the second group 3 are located above the light spots 2′ of the first group 1 and that at least the bottom row c of light spots 4′ are located mainly above the bottom row a of light spots 2′.

This arrangement yields the advantage of being able to generate a large number of different light distributions as needed for high beam, low beam (asymmetrical, symmetrical), motorway light, bend lighting, marker light, for example. Specifically, bend lighting and the marker light can be generated dynamically by driving the LED light sources for bend lighting with reference to the steering angle of the vehicle.

For example, there is the option of differently distributing the light from a right and a left headlamp so that they illuminate different parts of the road space. An alternative option is to make all or some LED light sources from a group emit light in the infrared spectrum. By being able to selectively illuminate danger points, the marker light function helps to improve on-road safety.

The first optical unit 5 and the second optical unit 6 both feature means of optical projection of a focal length that equals the distance between the means of optical projection and the first group 1 and the second group 3 of LED light sources 2, 4 or where said groups 1, 3 of LED light sources 2, 4 are located near the focal point of the means of optical projection.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A headlamp for vehicles with a plurality of LED light sources combined into a single light-emitting surface, where an optical unit is allocated to at least one LED light source to generate some of a specified light distribution, where one or several LED light sources can be turned on or off such that the light distribution can be modified, comprising:
a first optical unit (5) with a first projection characteristic placed before a first group (1) of LED light sources (2);
a second optical unit (6) with a second projection characteristic placed before a second group (3) of LED light sources (4) such that a number of differently sized light spots (2′, 4′) can be generated in the traffic space by optionally turning on or off or dimming the LED light sources (2) of the first group (1) of LED light sources (2) or the second group (3) of LED light sources (4).

2. The headlamp of claim 1, characterized in that said first projection characteristic of the first optical unit (5) and said second projection characteristic of the second optical unit (6) are designed such that at least some of the first partial light distribution (I1) generated by the LED light sources (2) of the first group (1) of LED light sources (2) is located underneath the second partial light distribution (12) generated by the LED light sources (4) of the second group (3) of LED light sources (4).

3. The headlamp of claim 1, characterized in that said first projection characteristics of the first optical unit (5) and said second projection characteristics of the second optical unit (6) are designed such that the light spots (2) of the first group (1) of LED light sources (2) are larger than the light spots (4′) of the second group (3) of LED light sources (4).

4. The headlamp of claim 1, characterized in that a control unit (7) is provided to turn on or off and/or to dim several LED light sources (2, 4) of the first group (1) and the second group (3) of LED light sources (2, 4) such that the light distribution (13, 16) resulting from the overlap between the first partial light distribution (11) and the second partial light distribution (12) is modified with reference to the road space situation.

5. The headlamp of claim 1, characterized in that the control unit (7) drives the LED light sources (2, 4) of the first group (1) and the second group (3) of LED light sources (2, 4) such that at least some of the cut-off line (HDG) moves in the direction of the curve when the vehicle goes round a bend.

6. The headlamp of claim 1, characterized in that a sensor unit (9) and a signal processing unit (8) are placed before the control unit (7) such that the LED light sources (2, 4) can be driven with reference to a control signal (10) representing the relative position between the vehicle and a danger point or traffic object in the traffic space such that the light emitted to illuminate the danger point is increased and/or the light emitted to illuminate the traffic object is reduced within a specified period of time.

7. The headlamp of claim 1, characterized in that the control unit (7) outputs a control signal to the first group (1) and the second group (3) of LED light sources (2, 4) that enables the LED light sources (2, 4) to be individually turned on or off or dimmed.

8. The headlamp of claim 1, characterized in that the first optical unit (5) and the second optical unit (6) feature an optical projector, where the light-emitting surfaces making up the substrate of the first group (1) and the second group (3) of LED light sources (2, 4) are located at or near a focal point of said optical projector of the first optical unit (5) or the second optical unit (6).

9. The headlamp of claim 1, characterized in that the first optical unit (5) is designed such that it can generate a row (a) of light spots (2′) of the first group (1) of LED light sources (2) immediately underneath a horizontal line (W) of a cut-off line (HDG) of the light distribution.

10. The headlamp of claim 1, characterized in that the second optical unit (6) is designed such that it can generate the light spots (4′) of the second group (3) of LED light sources (4) mainly above the horizontal line (W) of the cut-off line (HDG) of the light distribution.
